(19) United States
(12) Patent Application Publication
(10) Pub. No.: US 2012/0323765 A1
(43) Pub. Date: Dec. 20, 2012

(54) GIFT CARD TO CREDIT CARD TRANSFERENCE

(76) Inventors: Cory Spaulding, Yorktown, IN (US); Justen Michael Minnes, Stillwater, OK (US)

(21) Appl. No.: 13/163,052

(22) Filed: Jun. 17, 2011

(51) Int. Cl. G06Q 20/34

(52) U.S. Cl. 705/39

(57) ABSTRACT

Methods, systems, and apparatus, including computer programs encoded on a computer storage medium, for credit card and credit card like transaction enablers. In one aspect, a method includes receiving a credit card account associated with one or more gift card accounts, each respective gift card account associated with a respective balance; receiving notice of a transaction using the credit card account; determining whether a respective gift card account qualifies for use in the transaction; in response to determining that a respective gift card account qualifies for use in the transaction, determining whether to apply the respective balance to the transaction; in response to determining to apply the respective balance to the transaction, applying the respective balance to the transaction.

### TECHNICAL FIELD

This novel technology relates to fee based transaction enablers and, more specifically, to credit card and credit card like transaction enablers.

### BACKGROUND

A gift card is typically a device that has been charged with a certain dollar value. The gift card may be used by the holder to purchase goods or services from a designated merchant or merchants. Gift card transactions are generally authorized based upon the gift card's available balance and status. Since their introduction, gift card usage has increased to the point of being a $55 billion annual sales industry.

While popular with both consumers and merchants, gift cards have several drawbacks. First, because gift card transactions are generally authorized based upon the gift card's available balance and status that is typically stored upon the card itself, gift cards offer no protection from theft. Second, a buyer typically must have the gift card at the point of transaction in order to use the gift card for the transaction. For example, a gift card will often go unused because the gift card has been left at home instead of being upon the gift card holder at the point of transaction. The need to have the gift card at the point of transaction can also give rise to the situation where a person's wallet is uncomfortably full of gift cards. Similarly, the usage of the gift card in certain social situations may be socially unacceptable. For example, presenting a gift card for an expensive meal while on a date is largely held to be socially unacceptable. Third, because a gift card has a fixed value, the usage of gift card often results in a multi-step transaction. For example, a portion of a purchase is paid for with the gift card while a remaining portion of the purchase is paid using an additional means of payment. Finally, a gift card typically does not have a convenient means of obtaining a remaining, available balance. Thus, there is a need for the applicant's novel technology.

### SUMMARY

This novel technology relates to fee based transaction enablers and, more specifically, to credit card and credit card like transaction enablers.

In general, innovative aspect of the subject matter described in this specification may be embodied in methods that include the actions of receiving a credit card account that is associated with one or more gift card accounts, each respective gift card account associated with a respective balance and receiving notice of a transaction using the credit card account. Determining that at least one of the one or more associated gift cards qualify for use in the transaction, and determining to apply at least one of the one or more associated gift cards to the transaction, applying the balance of the at least one of the one or more associated gift cards to the transaction. Other embodiments of this aspect include corresponding systems, apparatus, and computer programs, configured to perform the actions of the methods, encoded on computer storage devices.

In general, one innovative aspect of the subject matter described in this specification may be embodied in a system implementation that includes a transaction processing engine capable of the action of receiving notice of a transaction using a credit card account that is associated with one or more gift cards, each respective gift card associated with a respective balance; determining that a respective gift card account qualifies for use in the transaction, and determining the balance of the respective gift card account to the transaction, applying the balance of the respective gift card account to the transaction; reducing the respective balance according to an amount of the respective balance applied to the transaction; and applying any unmet portion of the transaction to the credit card account.

Particular embodiments of the subject matter described in this specification may be implemented so as to realize one or more of the following advantages. Usage of a gift card is enabled without requiring actual and cotemporaneous possession of the gift card. In a like fashion, the usage of a gift card is enabled for transactions not normally gift card enabled. For example, an associated gift card may be applied towards a qualifying telephone or internet credit based transaction.

Similarly, because usage of a gift card is now not readily detectable, the potential social stigma stemming from a usage of a gift card in certain social situations is avoided. Also, the risk of loss of a gift card from theft or misplacement is reduced since the physical usage of a gift card that has been associated with a credit card account may be disabled. Likewise, the risk of non-usage or incomplete of a gift card is reduced since application of the gift card to a qualifying transaction may be automatic through usage of the associated credit card account. Furthermore, credit card consumer protection mechanisms and services may be extended to gift cards that have been associated with a credit card account.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an exemplary block diagram overview of a credit card transaction.

FIG. 2 is an exemplary block diagram overview of a credit card and gift card processing implementation.

FIG. 3 is an exemplary block diagram of a cardholder associating a gift card with a credit card account.

FIG. 4 is a flow diagram of an exemplary process flow of gift card processing for a credit card transaction.

FIG. 5 is a process diagram of a process to associate a credit card account with one or more gift cards.

FIG. 6 is block diagram of an example computer system that may be used to implement the methods described above.

Like reference numbers and designations in the various drawings indicate like elements.

### DETAILED DESCRIPTION

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

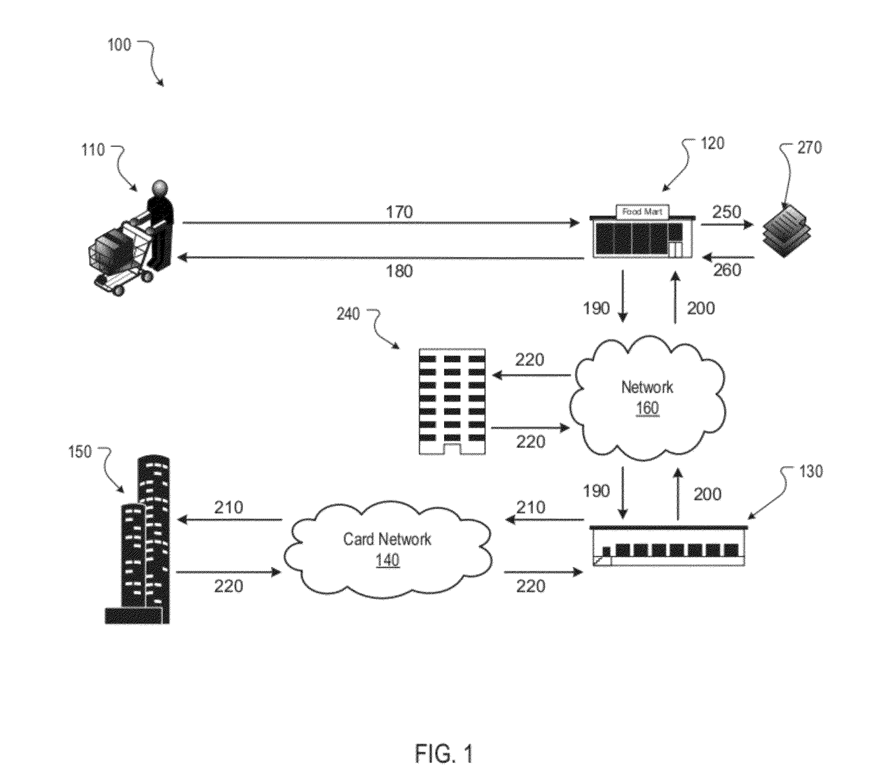

FIG. 1 is an exemplary block diagram overview of a credit card transaction 100. A credit card transaction may be broken down into four main phases. The four main phases are authorization, batching, clearing and finding. The authorization phase deals with enabling the transaction. The authorization phase begins with a cardholder 110 (e.g., a consumer) engaging 170 a merchant 120 (e.g., a convenience store or the like) in a transaction. The merchant 120 submits 190 a request authorization for the credit card transaction to an acquirer 130. An acquirer 130 is typically an entity who may be thought of as an intermediary between the merchant 120 and the credit card issuer 150. The submission 190 of the request for authorization is sent typically to the acquirer 130 through a network 160. The network 160 may include a local area network (LAN), a wide area network (WAN), the Internet, a telephone network and a wireless network, or a combination thereof. In some implementations, the request for authorization is also sent 220 to a collecting entity 240. The collecting entity 240 stores the request for authorization as a partial record of the transaction. In some implementations, the acquirer 130 and the collection entity 240 are the same entity.

The acquirer 130 typically requests 210 authorization for the transaction from the credit card issuer 150. The request for authorization is typically sent 210 to the credit card issuer 150 through a card network 140. The card network 140 may include a local area network (LAN), a wide area network (WAN), the Internet, a telephone network and a wireless network, or a combination thereof. Additionally, the card network 140 may include routing mechanisms that routes the request for authorization to the appropriate credit card issuer 150. In some implementations, the credit card issuer 150 responds 220 with authorization for the requested transaction if the credit card used for the transaction is valid. In some implementations, additional requirements are also considered before the credit card issuer 150 grants authorization. Examples of the additional requirements include the transaction meeting security tests, the transaction falling below a maximum amount, the existing balance on the credit card falling below a maximum amount, and the like.

After receiving authorization from the credit card issuer 150, the acquirer 130 sends 200 its own authorization for the transaction to the merchant 120. In some implementations, the collecting entity 240 stores the authorization as part of the record of the transaction. The merchant 120 receives 200 the authorization from the acquirer 130. The merchant 120 completes 180 the transaction with the card holder 110. In some implementations, the merchant 130 stores 250 the entire transaction in a data store 270.

The batching phase deals with supplying the information of all of the credit card transactions for a merchant 120 within a pre-defined time frame to an acquirer 130. The merchant 120 typically retrieves 260 all of his transactions for a pre-defined time period from the data store 270. The merchant 120 then sends 190 the transactions to the acquirer 130. In some implementations, the collection entity 240 is used as an intermediary to store and then later send 230 these transactions to the acquirer 130. In other implementations, the acquirer 130 continually batches the transactions as the requests for authorizations are sent to the acquirer 130 by the merchant 120 during the authorization phase.

The clearing phase deals with clearing and financing all the transactions within a batch. The acquirer 130 typically sends 210 an entire batch of transactions for clearing with the appropriate issuer 150. In some implementations, the card network 140 routes each individual transaction from a batch of transactions to the appropriate card issuer 150. The issuer 150 reviews its respective transactions and for each transaction granted, the issuer 150 subtracts a portion of the transaction as an interchange fee. In some implementations, a portion of the interchange fee is shared with entities composing the card network 140. The clearing phase ends with the card issuer 150 transferring 220 the remaining portion of the transaction to the acquirer 130.

The funding phase deals with supplying payment to the merchant. The acquirer 130 typically subtracts its discount fee from the portion of the amount the acquirer 130 received 220 from the card issuer 150 for the transaction. After reducing the amount by a discount fee, the acquirer 130 then transfers 200 the remaining portion of the transaction amount to the merchant 120.

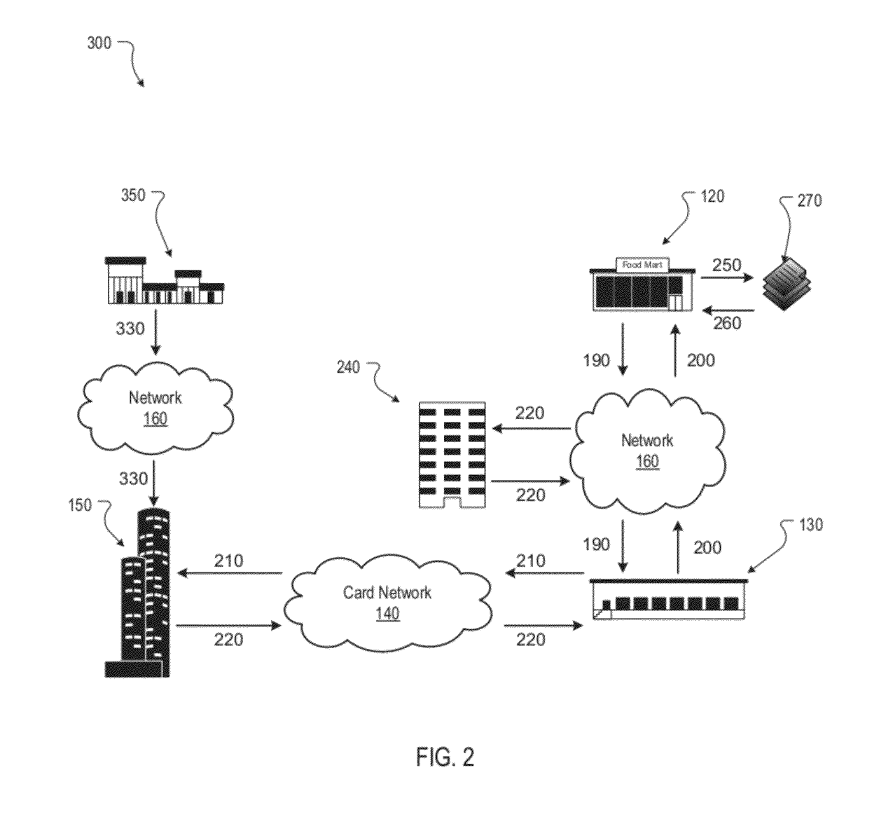

FIG. 2 is an exemplary block diagram overview of a credit card and gift card processing implementation 300. In an implementation, a gift card clearing house 350 is responsible for forming the associations between credit card accounts and gift cards. Periodically, the gift card clearing house 350 will send 330 to an appropriate issuer 150 a collection of credit card accounts that have been associated with gift cards. The association of credit card accounts and gift card accounts is explained below. In implementations, the gift card clearing house 350 sends 330 the collection of associated credit card accounts and gift cards through a network 160 to the appropriate issuer 150. In some implementations, the actual data sent by the gift card clearing house 350 to the issuer 150 is encrypted. In some implementations, the gift card clearing house 350 and the appropriate issuer 150 may be the same entity. In such implementations, there may be no need for the collection of credit cards and associated gift cards to the issuer 150.

In some implementations, the gift card clearing house 350 may utilize the card network 140 when sending 330 the collection of credit card accounts and associated gift cards. In such an implementation, the card network 140 may route the credit card accounts and respectively associated gift cards to the specific issuer 150 of the credit card accounts. For example, Visa credit card accounts issued by Chase Bank along with the respectively associated gift card accounts will be routed by the card network 140 to Chase Bank (Chase Bank would be the appropriate issuer 150 in this example).

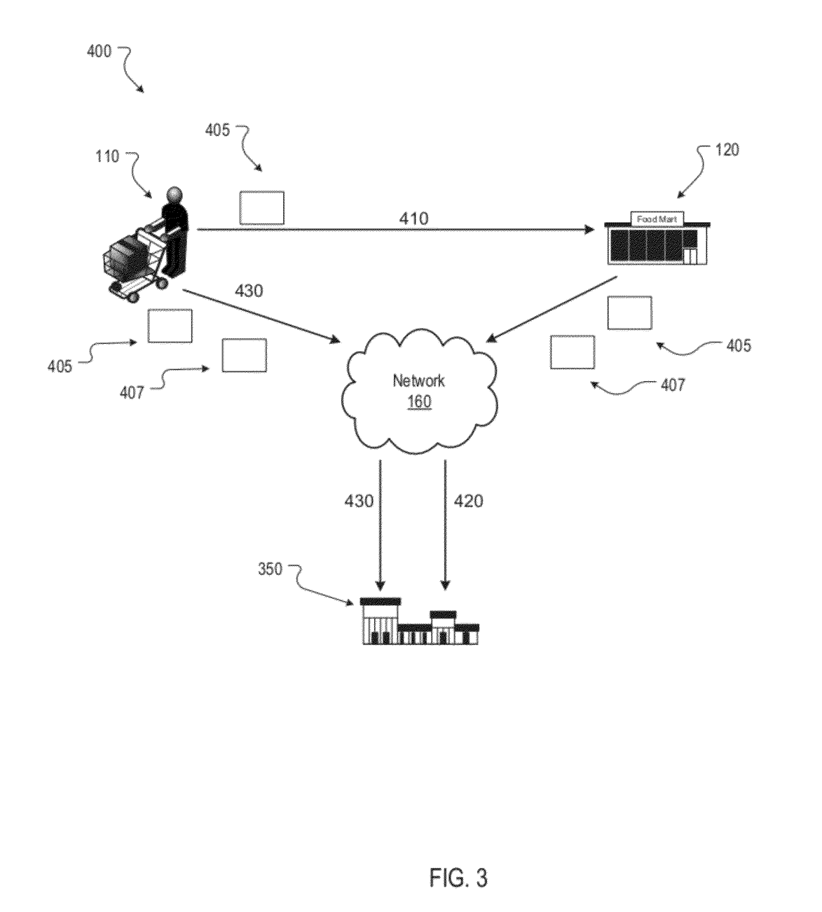

FIG. 3 is an exemplary block diagram 400 of a cardholder 110 associating a gift card 407 with a credit card account 405. In some implementations, a card holder may interact 410 with a merchant 120 to associate his credit card account 405 with a gift card 407. For example, the merchant 120 may offer the cardholder 110 the ability to associate his credit card account 405 with a gift card 407 during the purchase of the gift card 407 from the merchant 120. In some implementations, the cardholder 110 may enter into an interaction 430 where the cardholder's credit card account 405 is associated with a gift card 407 that the card holder 110 already possesses. For example, the cardholder 110 may access a website where he may associate his credit card account 405 with his pre-existing gift cards 407. In some implementations, the cardholder 110 may also specify gift card usage rules, processes, and constraints between the cardholder's credit card account 405 and the one or more gift cards 407. For example, the cardholder 110 may specify that an associated gift card 407 only be used for transactions under a certain amount. As an alternative example, the cardholder 110 could specify that the gift card's value be recharged at the end of every month. In this example, the credit card account would be charged with the amount required to recharge the associated gift card 405.

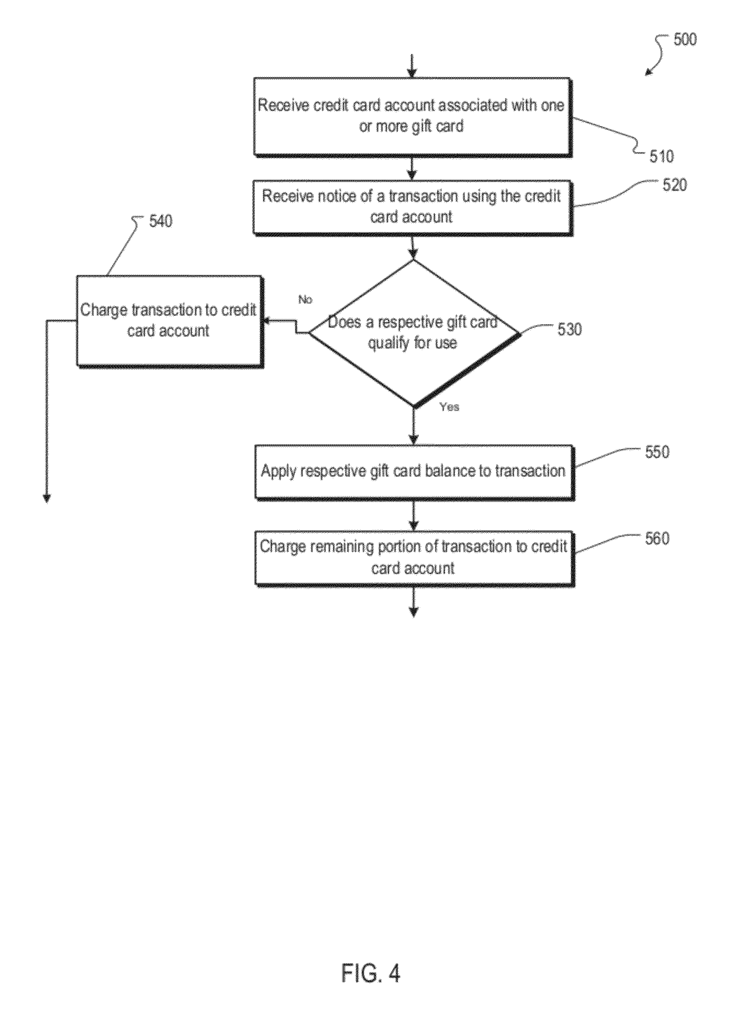

FIG. 4 is a flow diagram of an exemplary process flow 500 of gift card processing for a credit card transaction. A credit card account 405 associated with one or more gift cards 407 is received (510). Notice of a transaction using the credit card account 405 is received (520). In some implementations, the notice of the transaction using the credit card account 405 includes additional information specifying the gift cards 407 associated with the credit card account 405. In other implementations, the notice of the transaction using the credit card account 405 does not include information concerning gift cards 407 associated with the credit card. Instead, information concerning the gift cards associated with the credit card account 405 is retrieved from a data storage system.

Based upon the transaction, a determination is made as to whether or not a gift card 407 associated with the credit card account 405 qualifies for use in the transaction (530). In an implementation, the determination is based upon the associated gift cards 407, their respective balances and the transaction. In other implementations, the determination process also considers gift card usage rules. In such implementations, the cardholder 110 may place additional constraints and priority usage rules upon the usage of the associated gift cards 407. Examples of such additional constraints include minimum and maximum threshold amounts for gift card usage, date range for gift card usage, and transaction specific conditions for gift card usage. Examples of priority rules include rules providing for a preference for the usage of a first associated gift card over a second associated gift card for a given transaction. For example, the cardholder 110 could specify that an associated gift card to the cardholder's credit card account 405 be used for the purchase of a specific type of good. As another example, the cardholder 110 could specify to use the gift card 407 with the smallest remaining balance in the event that two or more associated gift cards qualified for usage in a transaction.

Should a gift card 407 associated with the credit card account 405 qualify for usage in the transaction, the balance of the respective gift card is applied to the transaction (550). In some implementations, cardholder specified rules may limit the amount of the gift card's balance applied to the transaction. Additionally, some implementations do not enable the application of the gift card's balance towards a transaction until receiving both a confirmation and a specified amount from the cardholder 110. Typically, such systems provide for notification of a transaction applicable gift card 407 to the cardholder 110. For example, a cardholder 110 may receive a notification that a gift card 407 associated with his credit card is applicable for a transaction. The transaction may be a recent previous transaction or, in some implementations, the cardholder 110 has the ability to pre-designate the usage of a gift card for a future transaction. In either situation, the cardholder 110 both approves and designates the portion of the gift card's balance to be applied to the transaction.

Note that applying the gift card's balance to the transaction results in a reduction of the respective balance of the gift card 407 in accordance to the amount applied to the transaction. In some implementations, a portion of the transactional amount paid by the gift card 407 is paid to the issuer 150. For example, the issuer 150 may subtract a portion of the gift card 407 covered amount of the transaction as an interchange fee.

Any remaining portion of the transaction is charged on the credit card account 405 (560). In some implementations, multiple gift cards 407 that are associated with the credit card account and that qualify for usage in the transaction may be applied to the transaction. In the event that no associated gift card qualified for usage in the transaction, the transaction is charged on the credit card account (540).

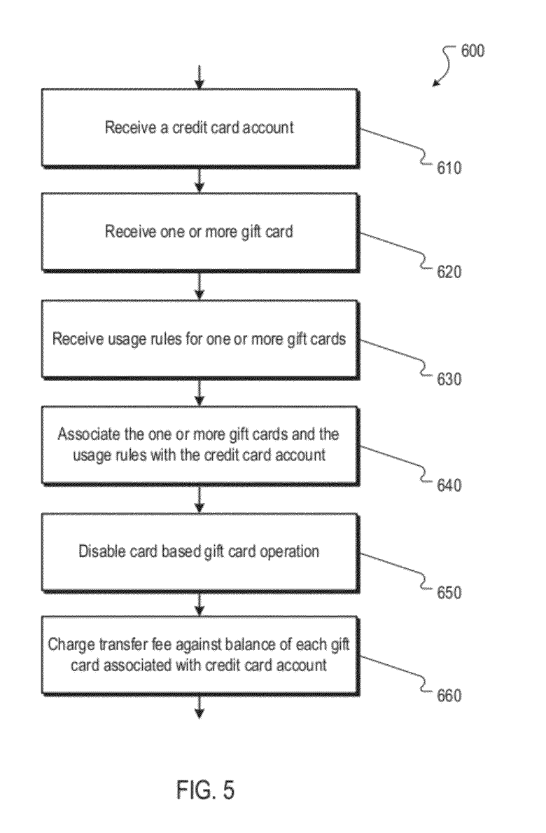

FIG. 5 is a process diagram of a process 600 to associate a credit card account 405 with one or more gift cards 407. A credit card account 405 is received (610). Typically, the credit card account 405 is received by a gift card clearing house 350. In some implementations, the credit card account 405 is received (610) from a cardholder 110 through the usage of an interface. For example, a cardholder 110 may input a credit card account 405 in a web or telephone enabled interface. In some implementations, the credit card account 405 is received (610) from a merchant 120. For example, the merchant may collect, to later send to the gift card clearing house 350, credit card account information when selling a gift card to a cardholder 110.

Data representing one or more gift cards 407 is received (620) by the gift card clearing house 350. In some implementations, rules governing the usage of the gift cards for appropriate transactions are also received (630) by the gift card clearing house. The gift card clearing house associates the one or more gift cards 407 and possibly usage rules with the credit card account 405. In some implementations, the ability to use the gift cards 407 by themselves is also disabled (640). In some implementations, a balance transfer fee is also charged against any gift card's balance (640). For example, the gift card clearing house 350 may charge a fee for the act of associating a gift card with a credit card account 405. In some implementations, the balance transfer fee may be charged against the received credit card account instead of the gift card's balance.

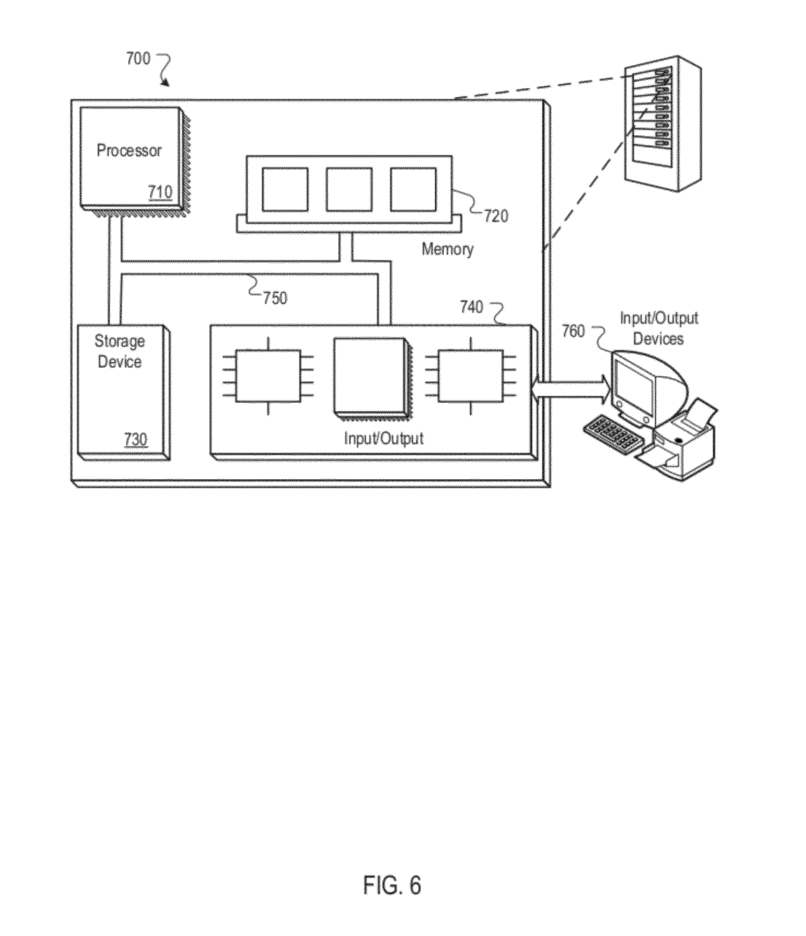

FIG. 6 is block diagram of an example computer system 700 that may be used to implement the methods described above. The system 700 includes a processor 710, a memory 720, a storage device 730, and an input/output device 740. Each of the components 710, 720, 730, and 740 may be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 420 or on the storage device 530.

The memory 720 stores information within the system 700. In one implementation, the memory 420 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may include, for example, a hard disk device, an optical disk device, or some other large capacity storage device.

The input/output device 440 provides input/output operations for the system 700. In one implementation, the input/output device 740 may include one or more of a network interface devices, e.g., an Ethernet card, a serial communication device, e.g., and RS-232 port, and/or a wireless interface device, e.g., and 802.11 card. In another implementation, the input/output device may include driver devices configured to receive input data and send output data to other input/output devices, e.g., keyboard, printer and display devices 760. Other implementations, however, may also be used, such as mobile computing devices, mobile communication devices, set-top box television client devices, etc.

Although an example processing system has been described in FIG. 6, implementations of the subject matter and the functional operations described in this specification may be implemented in other types of digital electronic circuitry, or in computer software, firmware, or hardware, including the structures disclosed in this specification and their structural equivalents, or in combinations of one or more of them.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer program instructions, encoded on computer storage medium for execution by, or to control the operation of, data processing apparatus. Alternatively or in addition, the program instructions may be encoded on an artificially-generated propagated signal, e.g., a machine-generated electrical, optical, or electromagnetic signal, that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate physical components or media (e.g., multiple CDs, disks, or other storage devices).

The operations described in this specification may be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Embodiments of the subject matter described in this specification may be implemented in a computing system that includes a back-end component, e.g., as a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) may be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination.

Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

While the novel technology has been illustrated and described in detail in the drawings and foregoing description, the same is to be considered as illustrative and not restrictive in character, it being understood that only the preferred embodiment has been shown and described and that all changes and modifications that come within the spirit of the novel technology are desired to be protected.

1. A method, comprising:
electronically receiving, by a computer device, a credit card account associated with one or more gift card accounts, each respective gift card account associated with a respective balance;
electronically receiving, by the computer device, notice of a transaction using the credit card account;
electronically determining, by the computer device, whether a respective gift card account qualifies for use in the transaction;
in response to determining that a respective gift card account qualifies for use in the transaction, electronically determining, by the computer device, whether to apply the respective balance to the transaction;
in response to determining to apply the respective balance to the transaction, electronically applying, by the computer device, the respective balance to the transaction;
periodically, electronically recharging a value of a gift card, the value applied against the credit card account.

2. The method of claim 1 wherein applying the respective balance to the transaction further comprises:
electronically reducing, by the computer device, the respective balance according to an amount of the respective balance applied to the transaction.

3. The method of claim 1 wherein applying the respective balance to the transaction further comprises:
electronically receiving, by the computer device, an allocation, from a user associated with the credit card account number, of the respective balance to the transaction.

4. The method of claim 1 wherein applying the respective balance to the transaction further comprises:
electronically determining, by the computer device, after applying the respective balance to the transaction, whether there is an unmet portion of the transaction;
in response to determining that there is an unmet portion of the transaction, electronically applying, by the computer, the credit card account to the unmet portion of the transaction.

5. The method of claim 1 further comprising:
electronically receiving, by the computer device, from a user associated with the credit card account, a set of priority rules, wherein the respective priority rules dictate balance allocation preferences.

6. The method of claim 1 wherein determining whether a respective gift card account qualifies for use in the transaction depends, at least in part, upon an issuer of the respective gift card account and a business associated with the transaction.

7. The method of claim 1, further comprising:
receiving, from a user, a credit card account number;
receiving, from the user, the one or more gift card accounts;
electronically associating, by the computer device, the one or more gift card accounts with the credit card account.

8. The method of claim 1, further comprising:
electronically disabling, by the computer device, card-use functionality of a gift card, wherein the gift card is associated with the credit card account.

9. The method of claim 1, wherein an amount of the transaction comprises:
an amount attributable to the transaction; and
a credit card issuer transactional fee.

10. The method of claim 7, further comprising:
electronically allocating, by the computer device, a portion of a balance of each gift card account associated with the credit card account to an issuer of the credit card account.

11. A system comprising:
a transaction processing engine stored in computer readable medium and comprising instructions executable by a processing device that upon such execution cause the processing device to:
receive notice of a transaction using a credit card account, the credit card account being associated with one or more gift card accounts, each respective gift card account associated with a respective balance;
determine whether a respective gift card account qualifies for use in the transaction;
in response to a determination that respective gift card account qualifies for use in the transaction, determine whether to apply the respective balance to the transaction;
in response to a determination to apply the respective balance to the transaction:
apply the respective balance to the transaction;
reduce the respective balance according to an amount of the respective balance applied to the transaction; and
apply an unmet portion of the transaction to the credit card account
periodically, recharge a value of one or more gift card accounts with each value used to recharge a gift card with applied against a balance of the credit card account.

12. The system of claim 11, further comprising:
a data store storing associations of credit card accounts and gift card accounts, wherein a credit card account is associated with one or more gift card accounts, each respective gift card account associated with a respective balance.

13. The system of claim 11, further comprising:
a data store storing associations of credit card accounts and priority rules, wherein each credit card account is associated with a respective set of priority rules, and the set of priority rules designate transactional balance allocation preferences to the credit card.

14. The system of claim 13, further comprising:
a data processing engine stored in computer readable medium and comprising instructions executable by a processing device that upon such execution cause the processing device to:
receive a credit card account;
receive one or more gift card accounts, each respective gift card account associated with a respective balance;
receive a set of priority rules;
associate the credit card account to the one or more gift card accounts; and
associate the set of priority rules to the credit card account.

15. A computer storage medium encoded with a computer program, the program comprising instructions that when executed by data processing apparatus cause the data processing apparatus to perform operations comprising:
receiving a credit card account associated with one or more gift card accounts, each respective gift card account associated with a respective balance;
receiving notice of a transaction using the credit card account;
determining whether a respective gift card account qualifies for use in the transaction;
in response to determining that a respective gift card account qualifies for use in the transaction, determining whether to apply a portion of the respective balance to the transaction;
in response to determining to apply a portion of the respective balance to the transaction, applying the portion of the respective balance to the transaction;
periodically, recharging a value of the gift card, the value applied against the credit card account.

16. The computer storage medium encoded with a computer program of claim 15, the program comprising instructions that when executed by data processing apparatus cause the data processing apparatus to perform further operations comprising:
reducing the respective balance according to an amount of the respective balance applied to the transaction.

17. The computer storage medium encoded with a computer program of claim 15, the program comprising instructions that when executed by data processing apparatus cause the data processing apparatus to perform further operations comprising:
determining, after applying the respective balance to the transaction, whether there is an unmet portion of the transaction;
in response to determining that there is an unmet portion of the transaction, applying the credit card account to the unmet portion of the transaction.
